(19) United States
(12) Patent Application Publication
(10) Pub. No.: US 2026/0187940 A1
(43) Pub. Date: Jul. 2, 2026

(54) MIXED REALITY TELEPRESENCE SYSTEM FOR DYNAMICALLY ADJUSTING VISUALIZATION OF OVERLAPPED SPACES AMONG MULTIPLE USERS

(71) Applicant: Korea Advanced Institute of Science and Technology, Daejeon (KR)

(72) Inventors: Sung-Hee Lee, Daejeon (KR); Taehei Kim, Daejeon (KR); Jihun Shin, Daejeon (KR); Hyeshim Kim, Daejeon (KR); Hyuckjin Jang, Daejeon (KR); Jiho Kang, Daejeon (KR)

(73) Assignee: Korea Advanced Institute of Science and Technology, Daejeon (KR)

(21) Appl. No.: 19/359,316

(22) Filed: Oct. 15, 2025

(30) Foreign Application Priority Data
Dec. 30, 2024 (KR) 10-2024-0199888

(51) Int. Cl. G06T 19/00; G06T 17/20; G06T 19/20

(52) U.S. Cl. CPC G06T 19/006; G06T 17/20; G06T 19/20; G06T 2219/024; G06T 2219/2004; G06T 2219/2016

(57) ABSTRACT

A telepresence system for dynamically adjusting visualization of overlapped spaces among multiple users according to the present invention comprises: a space information generator configured to scan the physical space of each geographically separated user to generate a 3D model and extract a floor plan from the 3D model; a space alignment unit configured to determine a shared space commonly used by each user using the floor plan, and to select and augment objects to be displayed in the shared space from the 3D model; and a visualization adjustment unit configured to generate a mixed reality image (scene) using the 3D model, the shared space, and the augmented objects, and to dynamically partition a non-shared space of another user in real time according to a user's position.

### CROSS-REFERENCE TO RELATED APPLICATION(S)

This application claims the priority benefit of Korean Patent Application No. 10-2024-0199888, filed on Dec. 30, 2024, in the Korean Intellectual Property Office, the disclosure of which is incorporated herein by reference.

### BACKGROUND

### 1. Field of the Invention

The present invention relates to a telepresence system which enables both verbal and non-verbal communication by dynamically adjusting visualization of overlapped spaces among multiple users so that each user's space is perceived as if all are connected into one.

### 2. Description of the Related Art

Telepresence technology allows people to communicate and collaborate in real time as if they are in the same space, even though they are physically located in different places.

If the spaces of geographically separated users are augmented into the counterpart's space through mixed reality technology so that they are perceived as same environment, immersive communication will be possible among users.

However, since the forms of the spaces where users reside are all different, it is not easy to find a common shared space that all users can use equally. The size of the shared space decreases as the number of users increases, making it difficult to collaborate or communicate within the shared space.

In other words, as more users connect to a telepresence system, the intersection of spaces that can be used in common decreases due to differences in each user's physical environment.

Furthermore, in conventional telepresence systems, each user only brings his or her avatar (virtual object) for communication, and thus there is no information about the counterpart's space, resulting in limitations to efficient and smooth communication.

Patent Document 0001 includes Korean Registered Patent No. 10-2546945

### SUMMARY

The present invention has been devised to solve the above problems. The objective of the invention is to provide a telepresence system capable of maximizing the shared space, which is a common area where all users' virtual or physical objects can interact.

Furthermore, The objective of the invention is to utilize the non-shared spaces of each users.

To achieve the above objectives, a telepresence system for dynamically adjusting visualization of overlapped spaces among multiple users comprises:
a space information generator for scanning the physical space of each geographically separated user to generate a 3D model and extract a floor plan from the 3D model;
a space alignment unit for determining a shared space commonly used by each user using the floor plan, and for selecting and augmenting objects to be displayed in the shared space from the 3D model; and
a visualization adjustment unit for generating a mixed reality image (scene) using the 3D model, the shared space, and the augmented objects, and for dynamically partitioning a non-shared space of another user in real time according to a user's position.

The invention also provides a method for dynamically adjusting visualization of overlapped spaces among multiple users, each step being executed by at least one processor, the method comprising:
scanning the physical space of each geographically separated user to generate a 3D model;
extracting a floor plan from the 3D model;
determining a shared space commonly used by each user using the floor plan;
selecting and augmenting objects to be displayed in the shared space from the 3D model; and
generating a mixed reality (MR) image(scene) using the 3D model, the shared space, and the augmented objects, and dynamically partitioning non-shared spaces of other users in real time according to a user's position.

According to the mixed reality telepresence system of the present invention, the optimization of the shared space usable by multiple users enables sufficient shared space to be secured for collaboration and communication even when the number of connected users increases.

Furthermore, by dynamically adjusting visualization of the non-shared spaces, each user can perceive the shared space (the augmented remote spaces) as part of his or her local environment, while being able to check what another user is doing in the non-shared space.

As a result, users can perceive that they are all in one space even without a specific purpose, thereby enabling efficient and immersive activities through both verbal and non-verbal communication.

Effects of the invention are not limited to the contents described above and still other effects not described herein will be clearly understood by one of ordinary skill in the art from the description set forth herein.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1: A schematic configuration of the mixed reality telepresence system for dynamically adjusting visualization of overlapped spaces among multiple users.

FIG. 2: A flowchart for explaining a method of dynamically adjusting visualization of overlapped spaces among multiple users.

FIGS. 3A, 3B, 3C, and 3D: Diagrams illustrating a process of dynamically adjusting visualization of overlapped spaces among multiple users.

FIGS. 4A, 4B, and 4C: Diagrams showing a result of dynamically adjusting visualization of overlapped spaces among multiple users.

FIGS. 5A, and 5B: Examples of application of the mixed reality telepresence system for dynamically adjusting visualization of overlapped spaces among multiple users.

FIGS. 6A, 6B, and 6C: Diagrams showing verification results of the mixed reality telepresence system for dynamically adjusting visualization of overlapped spaces among multiple users.

### DETAILED DESCRIPTION

Hereinafter, example embodiments of the invention are described in detail with reference to the accompanying drawings, such that one of ordinary skill in the art to which the invention pertains may easily implement the invention. However, the invention may be implemented in various different forms and is not limited to the example embodiments described herein. In the drawings, parts that are irrelevant to the description are omitted to clearly describe the example embodiments.

The terms used herein are simply used to explain a specific example embodiment and are not construed as limiting the invention. The singular expression may include the plural expression unless the context clearly indicates otherwise.

It will be further understood that the terms “comprises” and/or “comprising,” when used in this specification, specify the presence of stated features, integers, steps, operations, elements, components, and/or combinations thereof, but do not preclude the presence or addition of one or more other features, integers, steps, operations, elements, components, and/or combinations thereof.

Also, components shown in example embodiments are independently illustrated to represent different characteristic functions and do not indicate that each of the components is implemented as separate hardware or a single software configuration unit. That is, each component is described by listing each component for clarity of description, and at least two components among the components may be integrated into a single component or a single component may be divided into a plurality of components, to perform a function. An integrated example embodiment and separate example embodiment of each component is also included in the scope of the invention as far as it does not depart from the spirit of the invention.

Also, the following example embodiments are provided to provide clearer explanation to one of ordinary skill in the art, and shapes and sizes of components in the drawings may be exaggerated for clearer explanation.

Hereinafter, example embodiments will be described with reference to the accompanying drawings.

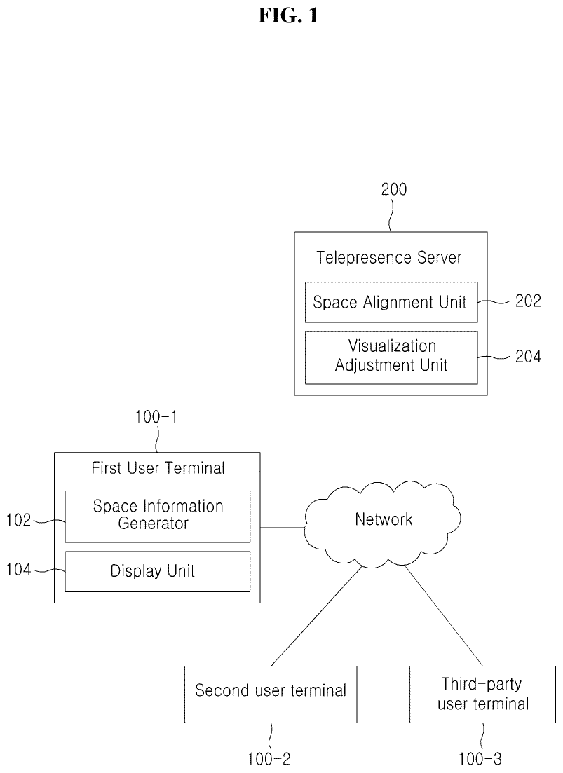

FIG. 1: A schematic configuration of the mixed reality telepresence system for dynamically adjusting visualization of overlapped spaces among multiple users.

FIG. 1 illustrates a schematic configuration of a mixed reality telepresence system for dynamically adjusting visualization of overlapped spaces among multiple users according to the present invention.

Referring to FIG. 1, the mixed reality telepresence system according to the present invention includes a plurality of user terminals (100) located in geographically separated positions, and a telepresence server (200) capable of implementing mixed reality telepresence among multiple users.

Each of the plurality of user terminals (100) is provided with a space information generator (102) and a display unit (104). The space information generator (102) and the display unit (104) may be included in one device or may exist as separate devices.

In an exemplary embodiment of the present invention, for convenience of explanation, the plurality of user terminals (100) are composed of a first user terminal (100-1), a second user terminal (100-2), and a third user terminal (100-3). However, the invention is not limited thereto, and it is obvious that mixed reality telepresence can be implemented among a greater number of users.

The space information generator (102) scans each geographically separated user's physical space (such as a room or office) to generate a 3D model and extracts a floor plan (2D Floor Plan) from the 3D model.

In order to generate the 3D model by scanning the physical space, the space information generator (102) may be provided with hardware such as a 3D scanner (LiDAR scanner, structured light scanner, laser scanner, etc.) or a camera. The space information generator (102) may also be provided with various kinds of floor plan extraction software to extract a floor plan from the 3D model.

The display unit (104) outputs to the user the mixed reality (MR) image (scene) in which telepresence is implemented. In the exemplary embodiment of the present invention, the mixed reality image (scene) displays the optimized shared space among multiple users, and the non-shared space of each user is displayed outside the shared space, the visualization of which is dynamically adjusted in real time.

To display a mixed reality telepresence image (scene), the display unit (104) may be composed of devices such as a display, hologram, projection, or an HMD (Head Mounted Display).

The telepresence server (200) includes a space alignment unit (202) for optimizing shared spaces among multiple users, and a visualization adjustment unit (204) for dynamically adjusting visualization of the non-shared spaces of each user in real time.

The space alignment unit (202) receives the 3D models and floor plans of each space from the plurality of user terminals (100), determines a shared space commonly used by the plurality of users using the floor plan, and selects and augments objects to be displayed in the shared space from the 3D model.

The visualization adjustment unit (204) dynamically adjusts the visualization of the non-shared space outside the shared space for each user.

The visualization adjustment unit (204) generates a mixed reality image (scene) using the shared space and augmented objects determined by the space alignment unit (202), together with the 3D model information, and dynamically partitions the non-shared spaces of other users in real time according to a user's position. In an exemplary embodiment of the present invention, the non-shared spaces are partitioned based on Voronoi regions for visualization adjustment.

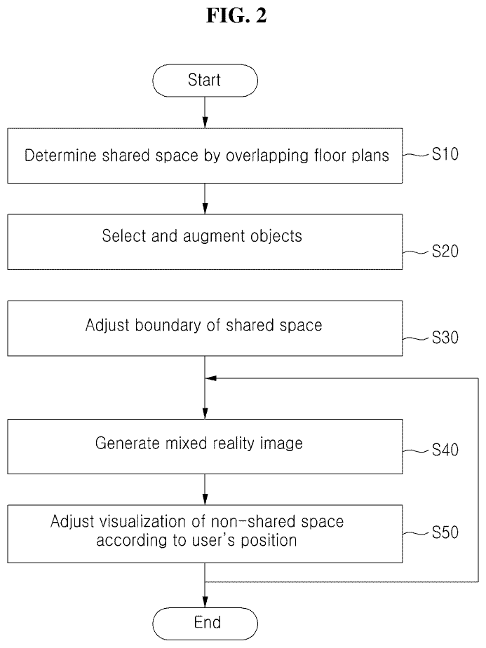

FIG. 2: A flowchart for explaining a method of dynamically adjusting visualization of overlapped spaces among multiple users.

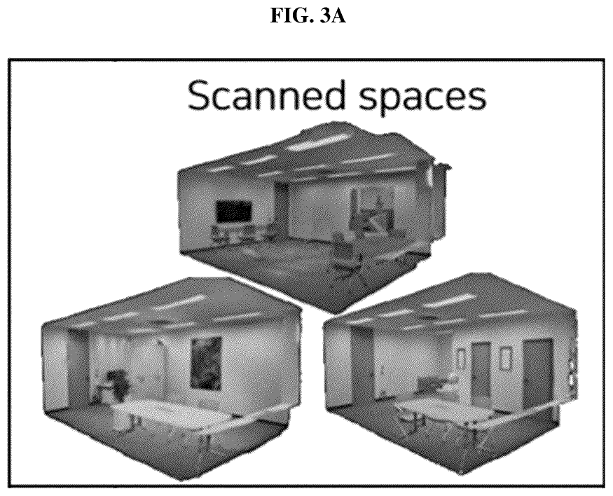

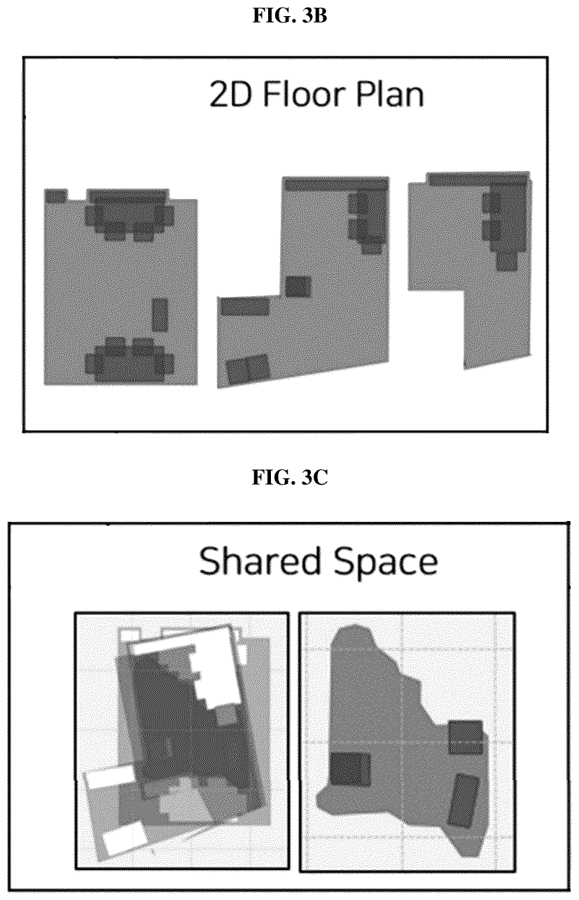

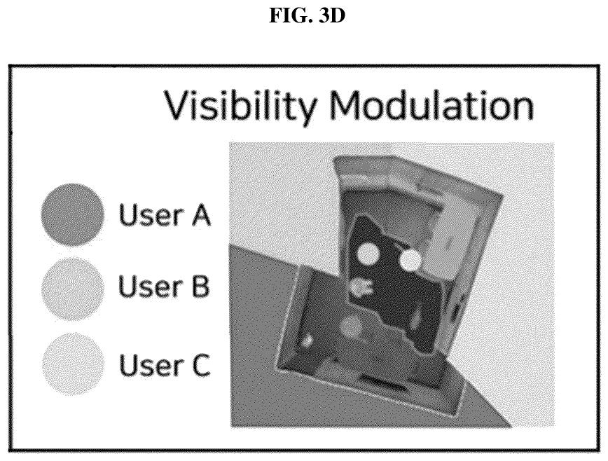

FIGS. 3A, 3B, 3C, and 3D: Diagrams illustrating a process of dynamically adjusting visualization of overlapped spaces among multiple users.

Referring primarily to FIG. 2, while referring to FIGS. 3A, 3B, 3C, and 3D to assist in understanding, the method for dynamically adjusting visualization of overlapped spaces among multiple users according to the present invention will be described below.

Each step shown in FIG. 2 is performed by the space alignment unit (202) and the visualization adjustment unit (204) of the telepresence server (200) according to the present invention.

The space alignment unit (202) overlaps floor plans received as input from the space information generator (102) of each user terminal (100) while rotating and horizontally moving them, and determines, as a shared space, a region in which the overlapped area excluding all objects in the floor plans is maximized (S10).

Referring to FIGS. 3A, 3B, 3C, and 3D, this process is illustrated in which a shared space (c) is determined by overlapping the floor plans (2D Floor Plan) (b) extracted from the 3D models (Scanned spaces) (a) of the spaces in which each user is located.

This optimization process for the shared space can be expressed by the following Equations (1) and (2).

$${E}_{i} = {S}_{i} - {⋃}_{k = 1}^{{m}_{i}} {O}_{i , k} \qquad [ Equation 1 ]$$

where Ei represents the remaining space after extracting all objects' areas from the floor plan, and Si represents the entire area of the floor plan.

$${A}_{e} = {max}_{{p}_{i} , {θ}_{i}} {⋂}_{i = 1}^{n} {E}_{i} \qquad [ Equation 2 ]$$

Subsequently, the alignment of the spaces is performed through optimization based on a probabilistic search algorithm (simulated annealing). That is, by determining the position Pi and rotation angle θi of each space, the shared space Ae is determined as the region in which the overlapped area of empty spaces Ei is maximized.

Next, the space alignment unit (202) performs an operation of selecting and augmenting objects to be displayed in the shared space (S20).

In the object augmentation step, digital copies of physical objects in one space are integrated into another space so as to add objects to the shared space. This object augmentation process can be expressed by the following Equation (3).

$$A = {A}_{e} {⋃}_{i , k} Augmentable ( {O}_{i , k} ) \qquad [ Equation 3 ]$$

where Ae represents the shared space and Ok represents an object to be augmented into the shared space.

When objects are augmented into the shared space, the space is expanded, and interactions between users and augmented objects become possible.

For example, consider a case where there is a chair (object) only in one space among multiple spaces. Without object augmentation, the region containing the chair is not regarded as a shared space for other users. However, when the chair is augmented, all participants can access the region occupied by the chair.

Meanwhile, since the purpose is to create a consistent and unified shared space for all participants, only objects located within the boundaries are augmented, and objects overlapping with other objects in participating spaces are not augmented to avoid confusion.

Once the object augmentation is completed, the space alignment unit (202) performs an operation of adjusting the boundary of the shared space (S30).

The initial output of the maximized shared space may include narrow regions that are not practically accessible by people. Accordingly, in order to smoothly shrink the outline of the shared space inward, a process of refining the shape of the shared space can be performed through a flood-fill approach.

After the optimization of the shared space and the object augmentation process are completed, the visualization adjustment unit (204) generates a mixed reality image (scene) using the 3D model, the shared space, and the augmented objects (S40), and performs an operation of determining, based on a Voronoi diagram, the non-shared space to be visualized according to each user's position (S50).

Referring to FIGS. 3A, 3B, 3C, and 3D, the spaces of users A, B, and C are connected into one, with the shared space displayed, and the non-shared spaces of each user displayed outside the shared space.

Within the shared space, users can interact as if they are in the same physical environment. However, in the non-shared space, users cannot coexist smoothly because differences occur in the overlapping regions among the spaces.

For example, in the same region, one space may contain furniture while another space may not, or a region inside one space may be located outside the boundary of another space.

To solve this problem, the present invention allows users to remain in their non-shared spaces through dynamic visualization adjustment, in which only one of the overlapped spaces is selectively visualized.

The principle for selecting such visualization is based on showing user behavior as clearly as possible, prioritizing the space closest to the user over a space farther away. Accordingly, even if a user cannot enter another user's non-shared space, the user can still check what the other user is doing in that non-shared space.

Dynamic visualization modulation according to the present invention can be achieved using a Voronoi diagram.

The Voronoi diagram subdivides a plane into cells based on scattered points, and each cell encloses the area closest to the given point.

In the case of the present invention, an infinite plane having points representing each user is assumed, and the Voronoi diagram divides the plane into cells. Each cell corresponds to an area in which the non-shared space of user i is visualized.

The visualization adjustment unit (204) visualizes each user's physical space through video pass-through technology, and visualizes the non-shared space of another user as a 3D digital replica while occluding a part of each user's physical space. Accordingly, each user can perceive the shared space (augmented remote spaces) as part of his or her local environment, creating the illusion that other users physically exist in his or her space.

At this time, the visualization adjustment unit (204) can visualize the non-shared space of another user in real time through shader computation.

That is, the Voronoi partition visualization of another user's non-shared space can be realized in real time using a shader algorithm. By executing Algorithm 1 shown below, it is determined whether or not to draw a fragment f of another user's non-shared space on the screen of user i, thereby visualizing the non-shared space.

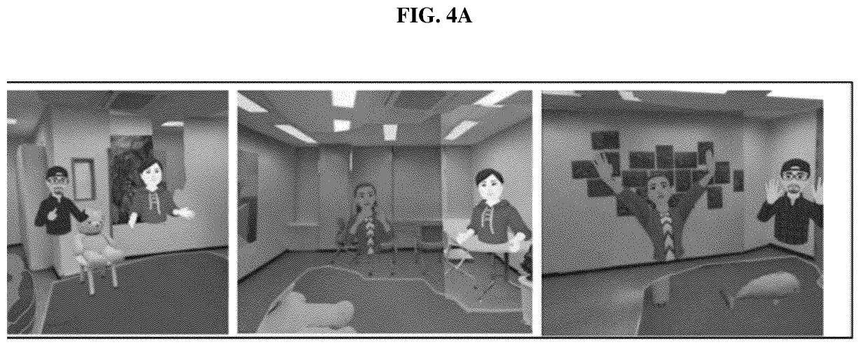

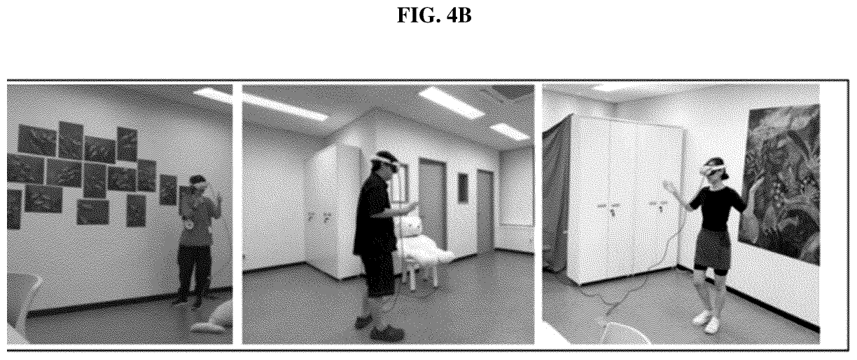

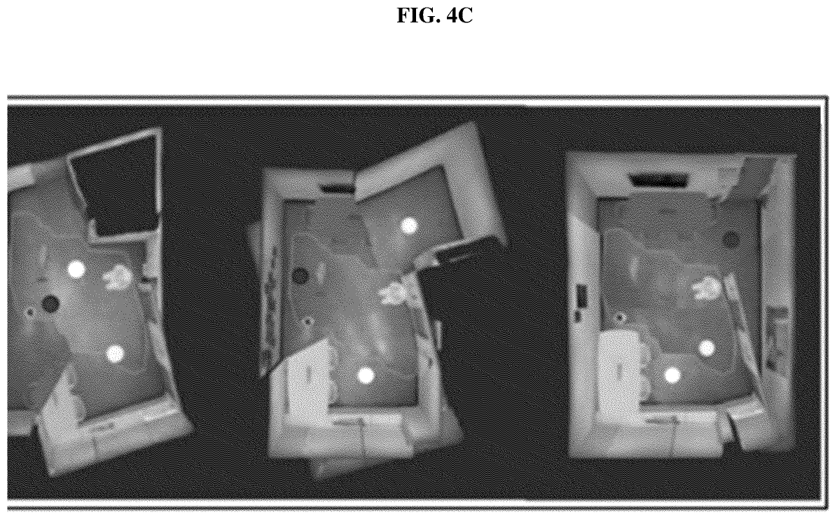

FIGS. 4A, 4B, and 4C: Diagrams showing a result of dynamically adjusting visualization of overlapped spaces among multiple users.

Referring to FIGS. 4A, 4B, and 4C. 4, (a) illustrates first-person viewpoints of users A, B, and C who are in different spaces; (b) illustrates a third-person viewpoint; and (c) illustrates regions viewable from various positions by each user (from top to bottom: user A, user B, and user C).

Each user introduces his or her space to other users who are geographically separated. Here, the green line indicates the shared space, i.e., the same space that all users can access.

The first mixed reality screen of (a) is the screen seen by user A, in which the shared space accessible by users B and C is indicated by the green line, the yellow region indicates the non-shared space where user B's appearance can be confirmed, and the gray region indicates the non-shared space where user C's appearance can be confirmed.

Similarly, the second mixed reality screen of (a) is the screen seen by user B, and the third mixed reality screen of (a) is the screen seen by user C. User B can see the shared space together with the non-shared spaces of users A and C, and user C can see the shared space together with the non-shared spaces of users A and B.

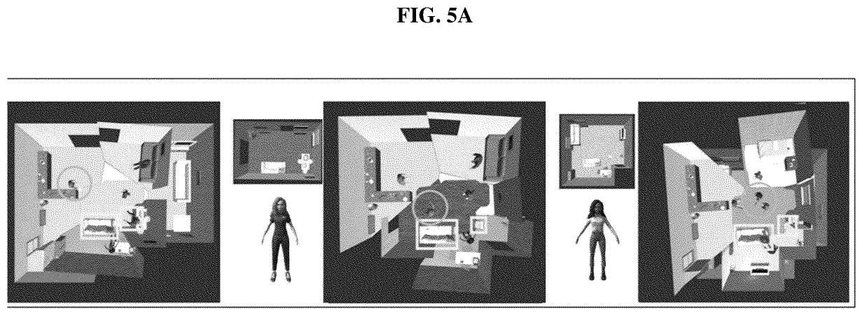

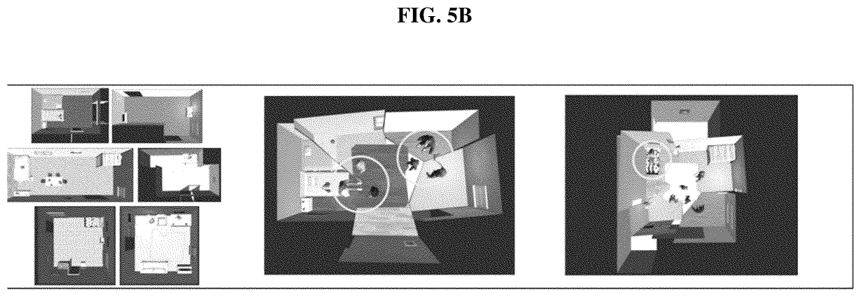

FIGS. 5A, and 5B illustrate application examples of the mixed reality telepresence system for dynamically adjusting visualization of overlapped spaces among multiple users according to the present invention.

Referring to FIG. 5, (a) shows a scene in which five users are taking a cooking class from different spaces, and (b) shows a scene in which six users are having a meeting from different spaces.

In (a), each user in a space is represented by a blue circle, and augmented objects are represented by yellow rectangles.

The left image shows the area viewable from user A's perspective, where the instructor (user A) is holding a plate, and other people are either sitting or standing.

The middle image shows the area viewable from user C's perspective, where users are starting to approach the instructor.

The right image shows the area viewable from user E's perspective, where users are gathering to ask questions.

In (b), pink circles indicate the regions to be focused on.

The left image shows six users participating in a meeting from different spaces.

The middle image shows the area viewable from user A's perspective, where some users are in the shared space and other users remain outside.

The right image shows the area viewable from user D's perspective, where one user is lying on a bed and other users are gathered together.

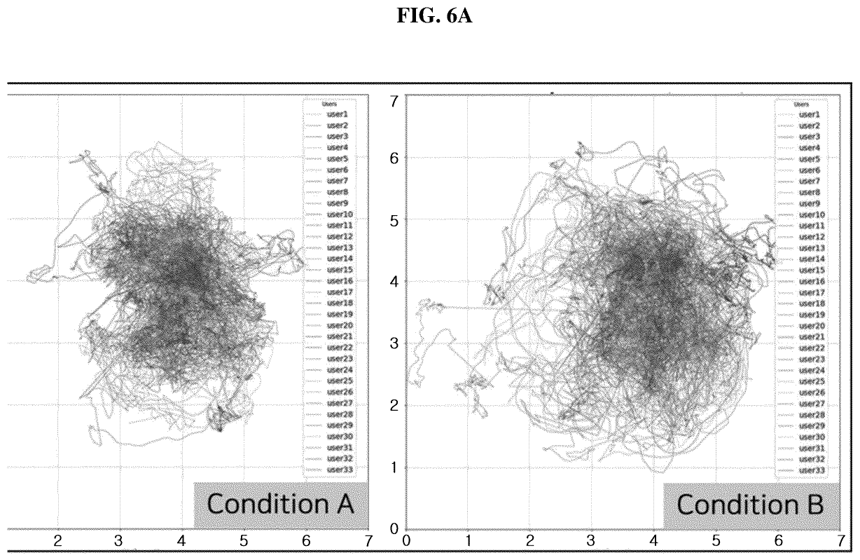

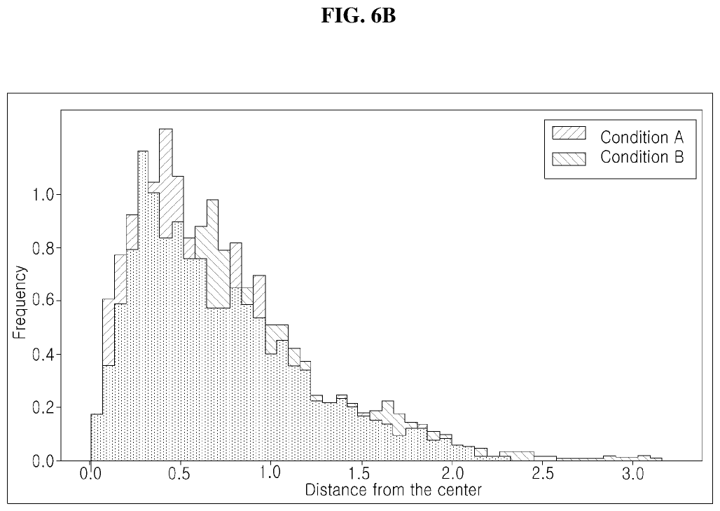

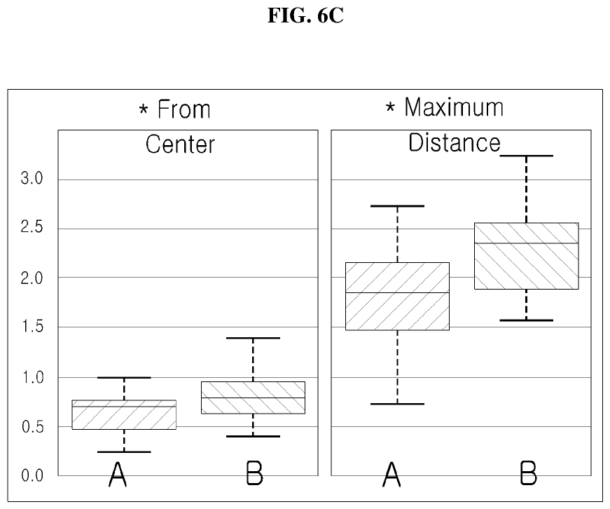

FIGS. 6A, 6B, and 6C illustrate verification results of the mixed reality telepresence system for dynamically adjusting visualization of overlapped spaces among multiple users according to the present invention.

Referring to FIG. 6, it shows the movement analysis of 33 users:
(a) shows movement patterns of the users,
(b) shows the distance distribution of the users from a reference position, and
(c) shows statistical results of the movement (average distance from the center of movement, maximum distance from the center of movement).

Condition A represents a conventional telepresence system, and Condition B represents the telepresence system according to the present invention.

From the results of user movement analysis, it can be confirmed that in the system of the present invention, compared with the conventional system, the users' ranges of movement are broader and their movements are more frequent, indicating that movements associated with collaboration and communication occur more actively.

Although the example embodiments have been described with reference to the accompanying drawings, it is provided as an example only and one of ordinary skill in the art will understand that various modifications and equivalent other example embodiments are possible therefrom. Therefore, the true technical scope of the invention should be determined by the technical spirit of the claims.

What is claimed is:

1. A mixed reality (MR) telepresence system for dynamically adjusting visualization of overlapped spaces among multiple users, comprising:
a space information generator configured to scan physical spaces of each geographically separated user to generate a 3D model and extract a floor plan from the 3D model;
a space alignment unit configured to determine a shared space commonly used by each user using the floor plan, and to select and augment objects to be displayed in the shared space from the 3D model; and
a visualization adjustment unit configured to generate a mixed reality image using the 3D model, the shared space, and the augmented objects, and to dynamically partition and augment non-shared spaces of other users in real time according to a user's position.

2. The system of claim 1, wherein the space alignment unit overlaps floor plans received from each space information generator while rotating and horizontally moving them, and determines, as the shared space, a region in which overlapped areas excluding all objects in the floor plans are maximized.

3. The system of claim 2, wherein the space alignment unit adjusts a boundary of the shared space using a Flood-Fill algorithm.

4. The system of claim 1, wherein the visualization adjustment unit visualizes each user's physical space using a video pass-through technique, and visualizes a non-shared space of another user as a 3D digital replica while occluding a part of each user's physical space.

5. The system of claim 4, wherein the visualization adjustment unit visualizes the non-shared space of another user in real time through shader computation.

6. The system of claim 1, wherein the visualization adjustment unit dynamically partitions non-shared spaces of other users in real time based on Voronoi regions.

7. A method of dynamically adjusting visualization of overlapped spaces among multiple users, each step being executed by at least one processor, the method comprising:
scanning physical spaces of each geographically separated user to generate a 3D model;
extracting a floor plan from the 3D model;
determining a shared space commonly used by each user using the floor plan;
selecting and augmenting objects to be displayed in the shared space from the 3D model; and
generating a mixed reality (MR) image using the 3D model, the shared space, and the augmented objects, and dynamically partitioning non-shared spaces of other users in real time according to a user's position.

8. The method of claim 7, wherein determining the shared space comprises overlapping floor plans while rotating and horizontally moving them, and determining a region in which overlapped areas excluding all objects in the floor plans are maximized.

9. The method of claim 7, wherein determining the shared space comprises adjusting a boundary of the shared space using a Flood-Fill algorithm.

10. The method of claim 7, wherein generating the mixed reality image comprises visualizing each user's physical space using a video pass-through technique, and visualizing a non-shared space of another user as a 3D digital replica while occluding a part of each user's physical space.

11. The method of claim 10, wherein visualizing the non-shared space of another user comprises performing real-time shader computation.

12. The method of claim 7, wherein dynamically partitioning the non-shared spaces of other users comprises partitioning the non-shared spaces in real time based on Voronoi regions.
